(19) United States
(12) Patent Application Publication
(10) Pub. No.: US 2004/0044668 A1
(43) Pub. Date: Mar. 4, 2004

(54) Collection view expander

(76) Inventor: Kevin Wade Jameson, Calgary (CA)

Correspondence Address: KEVIN JAMESON, 148 EDGEBANK PLACE NW, CALGARY, AB, T3A 4L4, CA

(21) Appl. No.: 10/227,847

(22) Filed: Aug. 27, 2002

(51) Int. Cl. G06F 7/00

(52) U.S. Cl. 707/100

(57) ABSTRACT

A Collection View Expander process improves human productivity by expanding collection views into detailed collection view information that can be used by application programs to manipulate collection views in advanced ways that were not previously possible. Collection views are groups of related collection references that can be processed by human workers using a single operation on a single set of collection references, rather than by performing a series of individual operations on individual collections. In operation, a Collection View Expander receives expansion requests from request originators, expands collection views into collection view information using detailed, user-defined collection view member reference type definitions, and returns aggregated collection view information to the request originators. Collection View Expanders improve human productivity by enabling people to represent and manipulate whole groups of collections as collection views.

### RELATED APPLICATIONS

Collection Information Manager, USPTO patent application Ser. No. 09/885,078, Kevin W Jameson, Jun. 21, 2001.

Collection Knowledge System, USPTO patent application Ser. No. 09/885,079, Kevin W Jameson, Jun. 21, 2001.

### FIELD OF INVENTION

This invention relates to software program methods for using single collections to represent and manage groups of other collections, thereby forming recursive data structures that can be easily manipulated by humans and programs, and thereby improving the productivity of people and computer systems that work with collections of computer files.

### BACKGROUND OF THE INVENTION

The present invention addresses the general problem of low productivity among human knowledge workers who use tedious manual procedures to work with collections of computer files. The most promising strategy for solving this productivity problem is to build automated computer systems to replace manual human effort.

One new software technology for improving productivity—software collections—enables computer programs to process collections of computer files more productively than previously possible. Collections are normal directory structures (“file folders”) of normal computer files, but they contain a special collection specifier file in the root directory of the collection. Collection specifier files specify, among other things, data types for collections. Computer programs can use collection data type values as lookup keys into databases to obtain detailed information about known collection data types. The detailed information obtained from the database enables computer programs to better understand the structure and content of the collections that they are processing. Having access to detailed information about collections enables programs to process collections in more intelligent ways than were previously possible

Collections are useful and practical because they make it easier for computer programs to manipulate the contents of collections. In one typical scenario, users invoke computer programs within a working directory contained within a collection directory structure. Computer programs recognize the location of the current collection by searching upwards for the special collection specifier file. Once programs know the physical location—the root directory—of the current collection, they can proceed to manipulate the collection to fulfill their processing functions.

Although the fundamental collection data structure enables programs to conveniently manipulate individual collections, programs cannot conveniently work with groups of related collections. No disciplined mechanisms exist for representing or manipulating groups of related collections.

The present Collection View Expander invention contemplates a method for representing and managing groups of related collections. Collection views solve the problem of representing groups of related collections by making it possible to list multiple collection view members within the collection specifier file of a host collection. But the collection view problem is somewhat complex, and so has several subproblems that require solutions. The following paragraphs briefly characterize several of those problems.

The Collection View Problem is one problem to solve. It is the problem of how to use individual collections to model groups of other collections. Solving this problem will enable users and programs to perform operations on whole groups of collections as easily as they can perform operations on individual collections.

The Collection View Problem has the following interesting aspects: multiple views may appear in a collection; a collection view may be comprised of an arbitrary number of collection view member references; each collection reference in the view collection may itself be a view collection that contains other views, thereby forming a recursive collection view data structure; collections may have arbitrary internal collection types; the referencing collection may want to treat referenced collections in various defined ways; and arbitrary operations may be performed on collection views.

The Collection View Type Problem is another problem to solve. It is the problem of how to assign different attributes to different collection views within the same collection. Solving this problem will enable people to treat different views in different ways, even if all members of the views are identical.

The Collection View Type Problem has the following interesting aspects: multiple attributes may be associated with each view type definition; view type definitions may be shared among many collections; view type attributes may be customized or overridden to meet special requirements; operations defined by view type definitions are typically applied to all members of the view, so they are called “view level” operations (as distinct from “collection level” operations).

The Collection View Member Reference Problem is another problem to solve. It is the problem of how to reference collection view members when members are stored in various data storage systems such as configuration management systems. A solution requires a practical syntax for referencing sets of collections, individual collections, or parts of collections within large repositories of collections.

The Collection View Member Reference Problem has these interesting aspects: a practical solution must permit references to individual collections, multiple collections within categories of collections, categories of collections, and all collections at a server location.

The Collection View Member Reference Type Problem is another problem to solve. It is the problem of how to associate sets of predefined attributes with view member references.

The Collection View Member Reference Type Problem has these interesting aspects: an arbitrary number of attributes may be involved in an attribute set; and attributes and attribute sets can be user-defined.

The Collection View Information Problem is another problem to solve. It is the problem of how to construct and deliver useful information about view member references to application programs.

The Collection View Information Problem has these interesting aspects: a solution must be independent of application program; it must allow different sites to control the values and meanings of view and view member reference attributes; it must provide for platform dependent information; and it must provide for arbitrary numbers of both view attributes and view member reference attributes and user-defined sets of view attributes.

The Platform Dependent Collection View Member Reference Problem is another problem to solve. It is the problem of how to represent platform-dependent collection view member references, so that people can include different references in a collection view, according to various computing platforms.

The Platform Dependent Collection View Member Reference Problem has these interesting aspects: platforms can be user-defined; an arbitrary number of platforms may be defined; hierarchies of virtual platforms may be defined; some references are platform independent.

The Product Dependent Collection View Problem is another problem to solve. It is the problem of how to represent collection views that are relevant to particular collection products.

The Product Dependent Collection View Problem has these interesting aspects: an arbitrary number of product dependent views may be specified; and the same view may be relevant to multiple products within a collection.

General Shortcomings of the Prior Art

The prior art contains no references that are relevant to the subject of the present invention. Even the related patent applications listed at the beginning of this document contain no mention of the problem of referencing collections by name. Accordingly, the following discussion is general in nature, because there are no specific works of prior art to discuss.

Prior art approaches lack support for collections. This is the largest limitation of all because it prevents people and programs from using high-level collection abstractions that can significantly improve productivity.

Prior art approaches lack means for referencing collections by name. This limitation prevents people and programs from referencing collections by name, within a collection namespace that is independent of local file system pathnames. For example, this prior art limitation prevents client programs from referencing collections that are stored on a server, where the client and server do not share file systems.

Prior art approaches lack means for using one collection to reference groups of other collections. This prevents people from processing groups of collections as easily as they can process individual collections. Instead, people must process groups of collections by tediously processing each collection in the group individually, one at a time.

Prior art approaches lack means for associating attributes and values with groups of collections, thereby preventing people from reusing shared sets of properties among groups of collections.

Prior art approaches lack means for associating attributes and values with individual members of a group of collections, thereby preventing people from reusing shared properties of individual group members for other group members.

Prior art approaches lack means for constructing and delivering useful attribute-value information about groups of collections to application programs. This prevents people and application programs from processing groups of collections in convenient, practical ways.

As can be seen from the above descriptions, prior art approaches lack the means to make it easy—or even possible—for people to conveniently work with groups of related collections. Prior art approaches lack practical means for modelling collections of files, for referencing collections by name, for modelling groups of related collections, for using stored knowledge in the form of data types and type definitions to understand groups of collections, and for automatically processing groups of collections.

In contrast, the present invention has none of these limitations, as the following disclosure will show.

### SUMMARY OF THE INVENTION

Collection View Expanders improve the productivity of knowledge workers in the information industry by organizing information about groups of related collections into collection view information data structures that can be used by automated collection processing systems. Collection views are normal collections that contain lists of collection view member references to other collections that comprise the collection view.

Collection view information is comprised of a collection view, including a collection view type and a list of collection view member references, and collection view type definition information and a list of corresponding collection view member reference type definition information.

In operation, collection view expanders analyze collection views to produce information-rich collection view information data structures for use by application programs. Application programs use collection view information to process collection views in useful, practical ways.

By using collection view information, automated programs can perform more complex software processes involving groups of collections than were previously possible, thereby improving the productivity of human knowledge workers. As manual human processes are replaced by automated collection processing systems, corresponding amounts of human effort will be freed up for more creative uses elsewhere.

### OBJECTS AND ADVANTAGES

The main object of the present invention is to improve the productivity of human knowledge workers by making it possible for them to conveniently work with groups of collections in the form of collection views.

Another object is to solve the Collection View Problem by providing a collection view modelling means for using individual collections to model groups of other collections. For example, collection views can be used to model lists of collections, software releases comprised of multiple collections, programs and their associated link libraries, and particular versions of groups of collections.

Another object is to solve the Collection View Type Problem by providing a collection view typing means for associating collection views with view type indicators and view type definitions.

Another object is to solve the Collection View Member Reference Problem by providing a collection view member reference syntax means for referencing collection view members in remote data storage systems.

Another object is to solve the Collection View Member Reference Type Problem by providing a collection view member reference typing means for associating type indicators and collection view member reference type definitions with collection view member references.

Another object is to solve the Collection View Information Problem by providing means for constructing and producing information-rich collection view information data structures for use by application programs.

Another object is to solve the Platform Dependent Collection View Member Reference Problem by providing means for associating collection view member references with particular, user-defined virtual platform names.

Another object is to solve the Product Dependent Collection View Problem by providing means for representing collection views within collection specifier product specification blocks.

Another object is to provide user-definable collection view types, thereby enabling application programs to access detailed information about collection views, and to process collection views in ways that were not previously possible.

Another object is to provide application programs with detailed information about collection views, thereby enabling more process automation among application programs that work with collection views.

As can be seen from the objects above, Collection View Expanders provide many useful and practical services to people and computer programs that work with collections.

Further advantages of the present Collection View Expander invention will become apparent from the drawings and disclosure that follow.

### BRIEF DESCRIPTION OF DRAWINGS

The following paragraphs introduce the drawings.

FIG. 1 shows a sample prior art file system folder from a typical personal computer.

FIG. 2 shows how a portion of the prior art folder in FIG. 1 has been converted into a collection 100 by the addition of a collection specifier file 102 named “cspec” FIG. 2 Line 5.

FIG. 3 shows the contents of a collection specifier file 102, implemented with a simple text file from a typical personal computer system.

FIG. 4 shows the structure of a full collection reference.

FIG. 5 shows several example collection references.

FIG. 6 shows a table of example shortcut references and their associated meanings.

FIG. 7 shows an example collection specifier containing two collection views. Each collection view contains multiple collection view member references, which are also known as typed collection references.

FIG. 8 shows the structure of a collection view member reference.

FIG. 9 shows several example collection view member references.

FIG. 10 shows an example name table for collection type names.

FIG. 11 shows an example collection type definition file for C program collections.

FIG. 12 shows an example name table for collection view member reference type names.

FIG. 13 shows an example collection view member reference type definition file for collection view member references of type “coil.”

FIG. 14 shows an example name table for collection view type names.

FIG. 15 shows an example collection view type definition file for collection views of type “view-default.”

FIG. 16 shows a simplified architecture for an Application Program Means 110 that uses a Collection View Expander Means 120 to obtain collection view information for use by the application program.

FIG. 17 shows a simplified, client-server architecture for an Application Program Means 110 that uses a Collection View Expander Client Means 140 and a Collection View Expander Server Means 141 to obtain collection view information for use by the application program.

FIG. 18 shows a simplified architecture for a Collection View Expander Means 120.

FIG. 19 shows a simplified algorithm for a Collection View Expander Means 120.

FIG. 20 shows a simplified data structure for collection view type information.

FIG. 21 shows a simplified data structure for a collection view member reference.

FIG. 22 shows a simplified data structure for a collection view member reference type definition.

FIG. 23 shows a simplified data structure for collection view information.

FIG. 24 shows an example source tree for a parent collection that contains a collection view that is comprised of a program and several link libraries.

FIG. 25 shows an example source tree for a link library referenced by the collection view member reference shown in FIG. 7 Line 1.

FIG. 26 shows an example source tree comprised of a parent source tree and source trees for each collection view member reference that is part of the parent's collection view specification. This is combined source tree illustrates how an application program could checkout a whole collection view in one operation, thereby improving human productivity.

FIG. 27 shows an example collection specifier file that contains platform-dependent collection view references.

FIG. 28 shows an example collection specifier file that contains product-dependent collection view references.

### LIST OF DRAWING REFERENCE NUMBERS

100 A collection formed from a prior art file folder

102 Collection specifier information

110 An Application Program Means

111 A Get Collection View Means

112 A Use Collection View Information Means

120 A Collection View Expander Means

121 A Get Collection View Type Name Means

122 A Get Collection View Type Definition Means

123 A Database of Collection View Type Definitions

124 A Get Collection View Member Reference Type Name Means

125 A Get Collection View Member Reference Type Definition Means

126 A Database of Collection View Member Reference Type Definitions

127 A Get Collection View Member Information Means

140 A Collection View Expander Client Means

141 A Collection View Expander Server Means

### DETAILED DESCRIPTION

The following disclosure describes the present Collection View Expander invention with reference to a preferred file system implementation of the invention. However, the invention is not limited to any particular computer architecture, operating system, file system, database, or other software implementation. The descriptions that follow should be considered as implementation examples only and not as limitations of the invention.

Introduction to Collections

Collections are sets of computer files that can be manipulated as a set, rather than as individual files. Collection information is comprised of three major parts: (1) a collection specifier that contains information—such as a collection data type—about a collection instance, (2) a collection type definition in a knowledge base that contains information about how to process all collections of a particular type, and (3) optional collection content in the form of arbitrary computer files that belong to a collection.

Collection specifiers contain information about a collection instance. For example, collection specifiers may define such things as the collection type, a text summary description of the collection, collection content members, derivable output products, collection processing information such as process parallelism limits, special collection processing steps, and program option overrides for programs that manipulate collections. Collection specifiers are typically implemented as simple key-value pairs in text files or database tables.

Collection type definitions are user-defined sets of attributes that are stored in a central knowledge base so they can be shared among multiple collections. In practice, collection specifiers contain collection type indicators that reference detailed collection type definitions that are externally stored and shared among all collections of a particular type. Collection type definitions typically define such things as collection types, product types, file types, action types, administrative policy preferences, and other information that is useful to application programs for understanding and processing collections.

Collection content is the set of all files and directories that are members of the collection. By convention, all files and directories recursively located within a collection subtree are collection content members. In addition, collection specifiers can contain collection content directives that add further files to the collection membership. Collection content is also called collection membership.

Collection is a term that refers to the union of a collection specifier and a set of collection content.

Collection information is a term that refers to the union of collection specifier information, collection type definition information, and collection content information.

Collections have many practical applications in the technical arts. They make it convenient for programs and human knowledge workers to manipulate whole sets of computer files where only individual files could be manipulated before. They make it possible to manipulate collections according to standard processing policies that are part of the collection type definition in a database.

Collection Representations

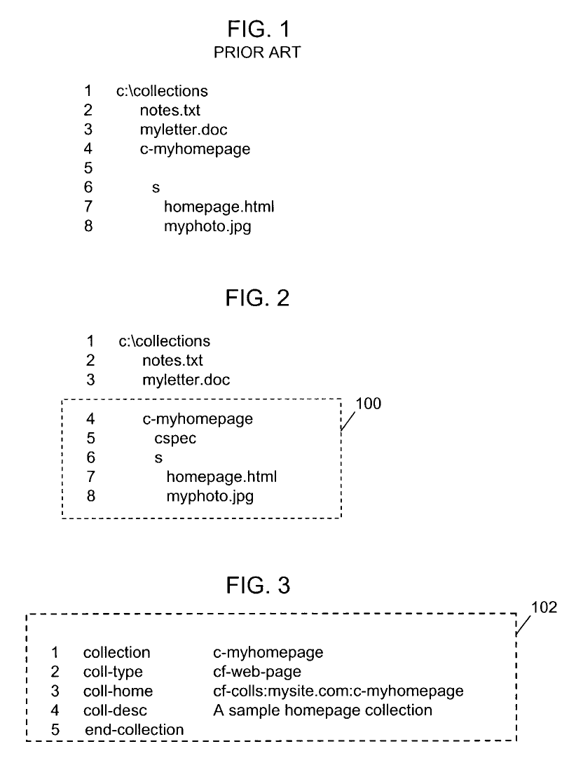

FIGS. 1-3 show a preferred embodiment of collections for a typical personal computer.

FIG. 1 shows a sample prior art file system folder from a typical personal computer.

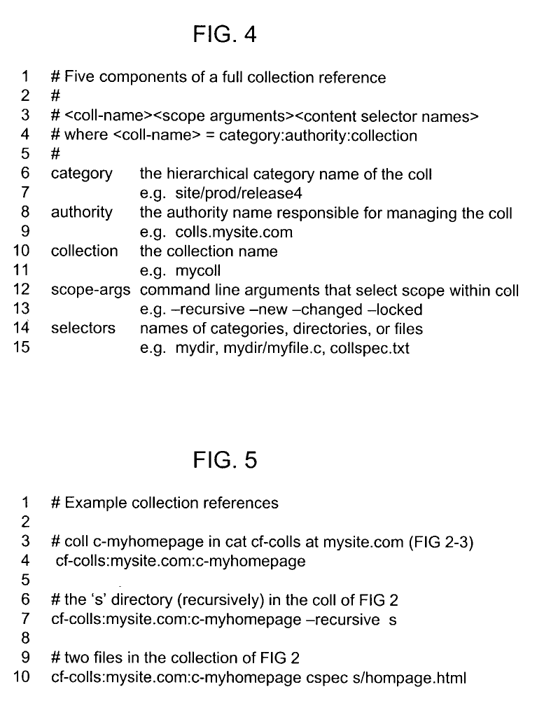

FIG. 2 shows the prior art folder of FIG. 1, but with a portion of the folder converted into a collection 100 by the addition of a collection specifier file FIG. 2 Line 5 named “cspec”. In this example, the collection contents FIG. 2 Lines 4-8 of collection 100 are defined by two implicit policies of a preferred implementation.

First is a policy to specify that the root directory of a collection is a directory that contains a collection specifier file. In this example, the root directory of a collection 100 is a directory named “c-myhomepage” FIG. 2 Line 4, which in turn contains a collection specifier file 102 named “cspec” FIG. 2 Line 5.

Second is a policy to specify that all files and directories in and below the root directory of a collection are part of the collection content. Therefore directory “s” FIG. 2 Line 6, file “homepage.html” FIG. 2 Line 7, and file “myphoto.jpg” FIG. 2 Line 8 are part of the collection content for collection 100.

FIG. 3 shows an example collection specifier file 102, FIG. 2 Line 5, for use on a typical personal computer file system.

Introduction to Collection References

Collections are useful and practical software containers for computer files because they make it easier to work with sets of related computer files. Programs can work with collections directly if the programs are invoked within the collection directory structure, but programs cannot reference collections from outside a collection without a proper means for doing so. The restriction of always being forced to work on collections from within their directory structures is a significant limitation in processing flexibility.

Collection references overcome this limitation by making it possible to conveniently refer to collections from outside a collection directory structure. Several different kinds of references are possible, as the following discussion shows. The discussion starts with simple expressions and builds up to collection references.

Expressions are comprised of sequences of characters. Expressions have no meaning until a human or program interprets them with respect to a set of interpretation rules. For example, numeric expressions are comprised of numbers. Alphabetic expressions are comprised of letters. Alphanumeric expressions are comprised of both letters and numbers.

References are comprised of expressions that refer to something when humans or programs interpret the references with respect to a set of interpretation rules. For convenience, humans often name or classify references according to (1) the syntactic form of the reference or to (2) the target of the reference (the referent). Examples of naming references after their syntactic form include numeric references, pointer references, HTTP URL references, and FTP references. Examples of naming references after the referents that are pointed to include document references, file references, and collection references.

Collection References are comprised of expressions that, when interpreted, refer to collections. Collection references can refer to collections in three ways: by name, by location, or by internal properties such as type or content.

References to collections by name only have meaning within collection namespaces that are defined by humans or application programs that manage entries in the namespace. For example, a configuration management system that “understood” collections would specify a particular syntax for referring to collections by name within the managed namespace. One example of a collection name syntax is “<category>: <authority>: <collection>.” The category part is a hierarchical expression that categorizes collections within the collection namespace. The authority part is the name of an authority (usually an Internet hostname such as foo.bar.com) that manages the collection namespace. The collection part is the name of a collection, within the category, within a collection namespace, that is managed by an authority.

References to collections by location are references to file folders or directories in computer file systems. This method works because collections are normally stored in file folders or hierarchical directory structures in computer file systems. The content of a directory structure, namely the presence of a collection specifier, ultimately determines whether the directory actually contains a collection.

References to collections by properties are search expressions that programs use to find and select interesting collections for processing. For example, a searcher might want to refer to all collections of a particular collection type within a collection namespace or within a computer file system.

Shortcut Collection References are short-form references that save people typing effort. The main idea of shortcut references is that people can save typing by omitting various parts of normal collection references. Application programs fill in the missing parts, using default values from the current local working collection, or from default values specified by the application program. Shortcut collection references are very useful in practice because they reduce typing effort and reduce knowledge burdens on human users. People don't have to remember details of long collection references. They can use easy-to-remember shortcut references instead.

Collection Reference Representations

FIGS. 4-6 show several formats for collection references and shortcut references.

FIG. 4 shows the structure of a complete collection reference. FIG. 4 Line 3 shows three main components of a preferred implementation of a complete collection reference—a collection name, a set of scoping arguments, and a set of content selector arguments.

A collection name is comprised of three parts—a category name, an authority name, and a collection name. A category name is a hierarchically structured name that groups related collections into categories, just as directory folders group related computer files into directories. An authority name is the name of the authority that is responsible for managing a collection. In practice, an authority name is an Internet Domain Name of a host computer that executes a server program for managing collections. A collection name is the name of a collection.

A collection reference scoping argument modifies a collection reference to refer to particular portions of a whole collection. For example, a “-recursive” scoping argument indicates that a reference should recursively include all directories and filenames below the recursion starting directory. Other examples of scoping arguments include “-new,” “-changed,” “-old,” “-local,” “-remote,” and “-locked.” These arguments limit the scope of a collection reference to particular directories and filenames by comparing a local collection copy with a remote authoritative collection copy. Scoping arguments help people to reference just the collection directories and files that interest them.

A collection reference content selector is a particular category, directory, or filename that limits a collection reference to include particular named categories, directories, or filenames. Whereas scoping arguments use properties of collection elements (e.g. new, locked, changed) to limit collection references, content selectors use explicit names of collection content members to limit collection references.

FIG. 5 shows several example collection references that use scoping arguments and content selector arguments. Lines 3-4 show a normal “whole collection” reference for the collection shown in FIG. 2. Lines 6-7 show a collection reference that is limited by scoping and selector arguments to a recursive subtree of the collection that is rooted at the “s” directory shown in FIG. 2 Line 6. Lines 9-10 show a collection reference that is limited by selector arguments to the “cspec” file FIG. 2 Line 5 and to the “s/homepage.html” file FIG. 2 Line 7.

Shortcut Collection References

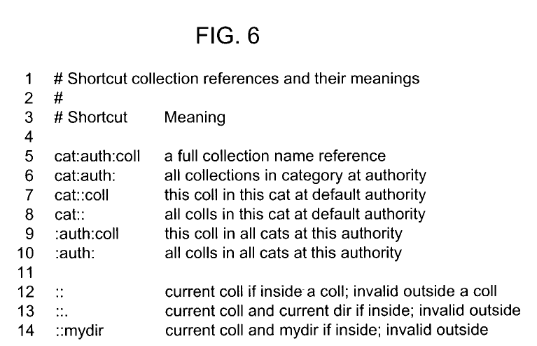

FIG. 6 shows a table of shortcut collection references and their meanings. A shortcut collection reference omits one or more parts of a normal three-part collection name. For example, FIG. 6 Line 6 shows a shortcut reference that omits the third component of a collection name, and thereby refers to “all collections” in the specified category at the specified authority.

Shortcut collection references are very useful in practice. They save typing. They reduce reference errors. They provide increased power and flexibility for referencing individual and multiple categories of collections, authorities, and individual collections. In fact, shortcut collection references have more referential power than complete three-part collection names. This is because complete collection names must provide specific values for a category and a collection, and so cannot refer to all categories, or all collections.

Local and Remote Collection References

FIG. 6 also shows both local and remote collection references. Lines 12-14 show local collection references, and Lines 5-10 show remote collection references.

Local Collection References refer to the current working collection. A current working collection for a program that is making a local collection reference is defined to contain the working directory of the program. Local collection references have no meaning, and are invalid, if no collection contains the working directory of a computer program that is making a local collection reference. In the examples presented in this disclosure, local collection references begin with a double colon “::” as shown in FIG. 6 Lines 12-14. Other syntaxes are also possible.

Remote Collection References do not depend on a program's current working directory being within a collection directory structure. A valid remote collection reference can be made from within any file system directory, whether inside or outside of a collection directory structure. In the examples presented in this disclosure, remote collection references do not start with a double colon “::” character sequence. Other syntaxes are also possible.

FIG. 6 Line 14 shows a reference that could be construed as a remote reference that means “all categories at all authorities that contain a collection called ‘dir’.” This interpretation is legitimate because it is in accordance with the conventions that have been presented above for remote collection references. But that is not the meaning used in this disclosure. Instead, it is more advantageous to use this particular syntax (“::dir”) to refer to local partial collections, for two reasons. First, this syntax is rarely, if ever, used for remote references in practice. Second, the double colon at the beginning of the reference makes it look like a local reference, so it would cause confusion among users if it were used as a remote reference. For these reasons, preferred implementations treat the syntax (“::dir”) as a local collection reference.

Keep in mind that the interpretation of any collection reference is ultimately determined by the implementation policies of the computer program that interprets the reference. This is why other syntaxes are also possible. For example, an application program could specify that local collection references should begin with a double sequence of a non-colon character such as “x.” Then the three shortcut local references shown in FIG. 6 Lines 12-14 would be “xx” “xx<dot>” and “xxdir” (where <dot>means a period). Or a slash could be used, giving “//” “//<dot>” and “//dir.” This disclosure, which explains a preferred implementation, uses double colons for shortcut local collection references, to maintain a consistent look among all collection references. Other implementations are also possible.

Introduction to Collection Views

Collections are useful for representing sets of computer files, and collection references are useful for referring to individual collections. But neither collections nor collection references are useful for referencing sets of collections. This is a significant limitation, because people often want to work with sets of collections, just as they want to work with sets of computer files.

Collection views solve the problem of referencing sets of collections by making it possible for one collection to represent sets of other collections. Collection views enable people and programs to perform operations on whole sets of collections as easily as they can perform operations on single collections.

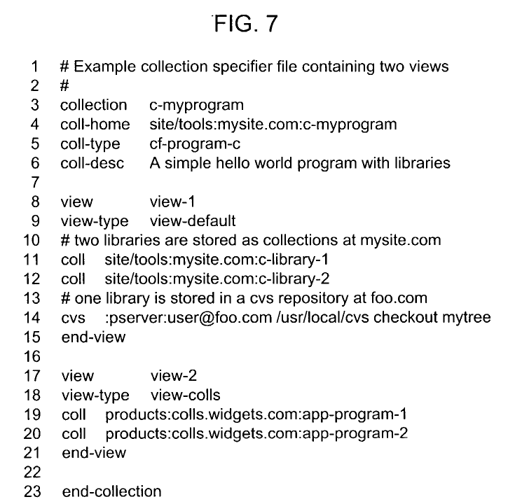

Collection Views are lists of references to other collections. FIG. 7 Lines 17-21 show an example collection view. Collection views are comprised of a view name, a view type, and a list of view member references. A collection view name is a user-defined value that provides a means for referring to the view. A collection view type is a type indicator that associates a view with a particular set of attribute-value pairs that specify useful information about all views of a particular view type. Each unique set of attribute-value pairs is called a collection view type definition. A collection view member reference is a reference that is part of the contents of a collection view.

Collection View Members are physical collections or source trees that are targets of collection view member references contained in collection views. FIG. 2 shows a collection that could be a collection view member. Collection view members are pointed to by collection view member references.

Collection View Member References are references that point to collection view members. FIG. 7 Line 19 shows a collection view member reference. Collection view member references are comprised of collection view member reference types and collection view member reference expressions.

Collection View Member Reference Types are type indicators that associate view member references with particular sets of attribute-value pairs that specify useful information about all view member references of a particular collection view member reference type. Each unique set of attribute-value pairs is called a collection view member reference type definition. FIG. 7 Line 18 Column 2 shows a collection view member type indicator.

Collection View Member Reference Expressions identify particular collections or source trees of computer files that comprise a collection view member. FIG. 7 Line 19 Column 2 shows one example of a collection view member reference expression. FIG. 7 Line 14 Columns 2-N shows a second example of a collection view member reference expression. Application programs use view member reference expressions to access or manipulate view member collections or source trees.

Collection view member reference expressions can take many syntactic forms, corresponding to how the physical collections or source trees are stored. For example, view member reference expressions can be collection reference expressions that name collections, expressions that name modules stored in configuration management systems, URL (Uniform Resource Locator) expressions that point to directories stored on remote servers, or any other kinds of expressions that can be used to identify source trees of computer files that comprise collection view members.

Collection View Representations

FIGS. 7-9 illustrate the structure and format of collection views.

FIG. 7 shows an example collection specifier that contains two collection views. Lines 8-15 show a first view named “view-1” and Lines 17-21 show a second view named “view-2.”

FIG. 7 Lines 17-21 show the structure of a collection view. Line 17 begins the view and specifies the collection view name. Line 18 specifies the collection view type, which associates the view with a set of attribute-value pairs defined in a corresponding collection view type definition. Lines 19-20 specify two collection view member references. Line 21 terminates the collection view.

FIG. 7 Line 19 shows the structure of a collection view member reference. Column 1 specifies a collection view member reference type, which associates a view member reference expression Column 2 with a set of attribute-value pairs defined in a corresponding collection view member reference type definition. Columns 2-N specify a collection view member reference expression and optional arguments.

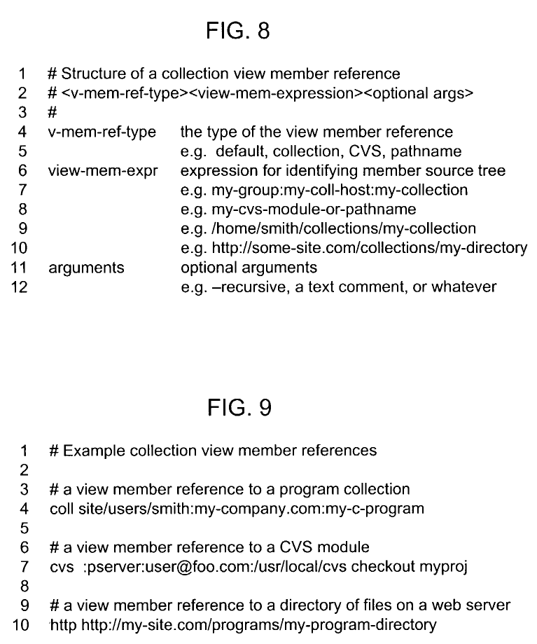

FIG. 8 shows the formal structure of a collection view member reference. Line 2 specifies that a collection view member reference is comprised of three parts—a view member reference type, a view member reference expression, and optional arguments. The functions of these three parts were described in the previous paragraph.

FIG. 9 shows several example collection view member references that contain different view member types and view member reference expression syntaxes.

Introduction to Types and Decorations

Collections, collection references, and collection views are all useful data structures for holding information, but none of them provides information to help programs process the contents of data structures in smart ways.

A better approach to smart processing of these data structures is to provide programs with a separate source of information that contains detailed information about the data structures and the contents therein. That way, programs can read the separate information to easily understand how to process the information content of the three data structures. Types and decorations are a means for providing the separate information.

Types are comprised of a type indicator and a type definition. A type definition contains sets of attribute-value pairs.

Decorations are attribute-value pairs from a type definition. When a collection, collection reference, or collection view is combined with a set of attribute-values pairs from a type definition, we say that it is “decorated.”

Programs usually decorate data structures using the following process. First, programs obtain a collection, collection reference, or collection view data structure to decorate. Second, programs obtain a type indicator for, or from, the data structure. Third, programs use the type indicator to obtain type definition information (decorations) corresponding to the type indicator. Fourth, programs decorate the original data structure by associating it with the attribute-value pairs (decorations) retrieved from the type definition.

Programs determine type indicators in two ways. If a type indicator is part of the original data structure, as is the case for collections and collection views, programs retrieve the type indicator from the data structure. If a type indicator is not part of the original data structure, as is the case with collection references, then programs must calculate a type indicator using other means. Perhaps programs analyze the contents of the data structure to calculate a type, or perhaps they retrieve an external, but associated, type indicator that is not part of the original data structure.

The use of types and decorations gives rise to several new classifications of collection, collection reference, and collection view data structures. Now we can have typed and decorated versions of each data structure. The following paragraphs define each new combination.

Typed Data Structures

Typed Collections are the same as normal collections because normal collections already contain a type indicator as part of the collection data structure. The terms “collection” and “typed collection” are synonymous. FIG. 3 Line 2 Column 2 shows a collection type indicator within a collection specifier file.

Typed Collection References are comprised of an external type indicator and a normal collection reference. FIG. 7 Line 19 shows a typed collection reference. Column 1 specifies a collection reference type and Column 2 specifies a collection reference. Typed collection references are called collection view member references when they appear within collection views.

Typed Collection Views are the same as normal collection views because normal collection views already contain a type indicator as part of the collection view data structure. The terms “collection view” and “typed collection view” are synonymous. FIG. 7 Line 18 Column 2 shows a collection view type indicator within a collection view within a collection specifier.

Decorated Data Structures

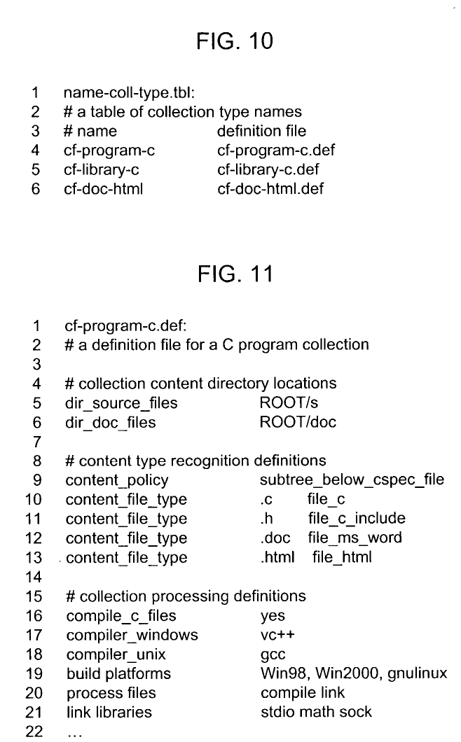

Decorated Collections are comprised of a collection and decorations in the form of attribute-value pairs from a collection type definition. Decorations specify interesting properties shared by all collections of a particular collection type. Decorated collections are the most useful type of collections to application programs, because they contain decorations that help to tell application programs how to process the decorated collections. FIG. 10 shows an example lookup name table of collection type names. FIG. 11 shows an example collection type definition (decorations). In operation, application programs look up type names in a name table FIG. 10 Column 1 to obtain names of corresponding type definition files FIG. 10 Column 2.

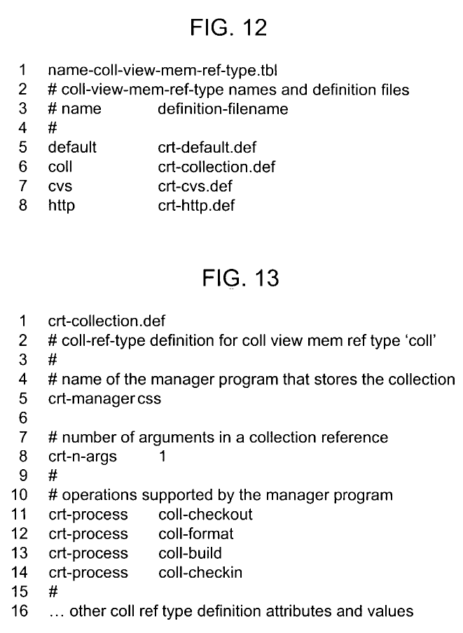

Decorated Collection References are comprised of a collection reference and decorations in the form of attribute-value pairs from a collection reference type definition. Decorations specify interesting properties shared by all collection references of a particular collection reference type. Decorated collection references are the most useful type of collection references for application programs, because the decorations help to tell application programs how to process the decorated collection references. For example, suppose that some attribute-value pairs specified the name of a collection namespace, and how to contact the authority for that namespace. Then an application program could use those attribute-value pairs to contact the authority responsible for the namespace. FIG. 12 shows an example lookup name table of collection view member reference type names. FIG. 13 shows an example collection view member reference type definition (decorations).

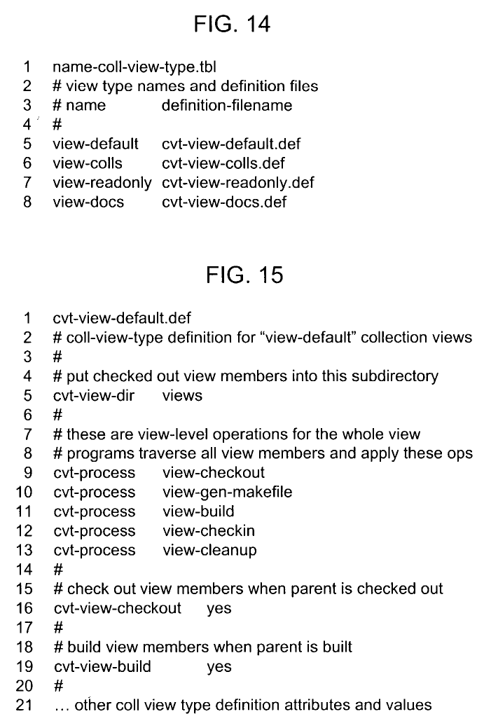

Decorated Collection Views are comprised of (1) a collection view, (2) decorations that specify properties of the collection view, and (3) decorations that specify interesting properties of each of the typed collection references in the view. Decorated collection views are the most useful kind of collection views for application programs because they contain detailed information that help to tell the application programs how to process decorated collection views. FIG. 14 shows an example lookup table of collection view type names. FIG. 15 shows an example collection view type definition (decorations).

Each of the normal, typed, and decorated forms listed above is useful for particular purposes. The normal form of a data structure is efficient for holding the core data content of interest. The typed form of a data structure is most convenient for humans, because it replaces long lists of decorations with a single type indicator token. Finally, the decorated form of a data structure is most convenient for application programs, because it contains additional useful information that helps programs to process the decorated data structures in more useful and more appropriate ways.

Conversion Among Normal, Typed, and Decorated Forms

Since each of the normal, typed, and decorated forms is useful for particular purposes, it is also useful for application programs to convert back and forth among the various representations.

Collection Information Managers are programs that convert typed collections into decorated collections. Recall that typed collections are the same as normal collections because normal collections already contain collection type indicators. Collection information managers produce “collection information” that represents decorated collections.

Collection Information is comprised of a collection specifier, collection type definition information, and collection content information.

Collection Shortcut Expanders are programs that convert shortcut collection references into complete collection references.

Collection View Expanders are programs that convert typed collection views into decorated collection views. Recall that typed collection views are the same as normal collection views because normal collection views already contain collection view types. Collection view expanders produce “collection view information” that represents decorated collection views.

Collection View Information is comprised of a collection view, including a collection view type and a list of collection view member references, and collection view type definition information and a list of corresponding collection view member reference type definition information. Collection view information is nearly equivalent to a list of decorated collection references, with the addition of collection view type definition information.

Collection View-Enabled Program Architectures

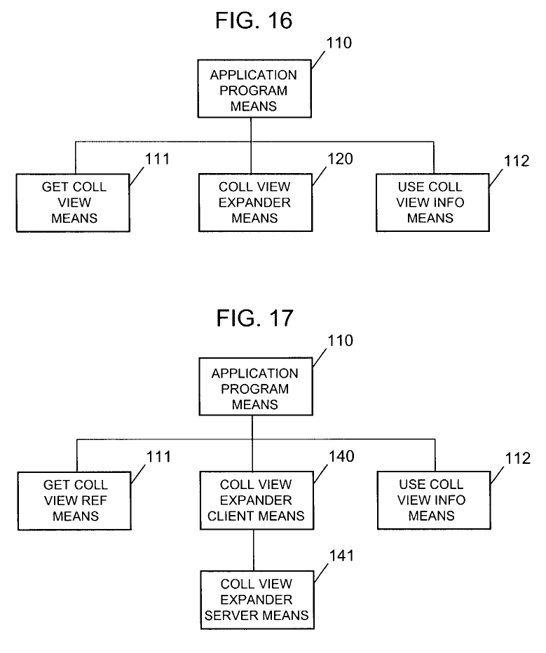

FIGS. 16-17 show example collection view-enabled application program architectures. The term “collection view enabled” denotes an ability to work with collections and collection views. For example, collection view enabled programs can recognize collections, read collection specifier files, and obtain collection type information and collection view information from a database. Collection view enabled programs can process collection contents and collection views according to policies defined collection type definitions and collection view type definitions.

FIG. 16 shows how a collection view enabled application program 110 could work with collection views.

In operation, the application program 110 would obtain one or more collection views from a collection specifier FIG. 7 using a Get Collection View Means 111, expand the collection view into collection view information using a Collection View Expander Means 120, and then utilize the obtained collection view information using a Use Collection View Information Means 112. Typically, human users improve their productivity by invoking collection view enabled programs to perform useful operations on whole collection views.

FIG. 17 shows how a collection view enabled application program 110 could obtain collection view information using a client-server implementation comprised of a Collection View Expander Client Means 140 and a Collection View Expander Server Means 141. A client-server implementation can share a single database of type information among many application programs.

One example of a typical collection view operation is to check out a whole collection view from a configuration management system. This operation solves a typical problem faced by software developers, who frequently need to simultaneously work on multiple source trees that comprise a software application. Without views, developers must identify and check out each individual source tree that is part of the application program. But with collection views, developers only need to check out a parent collection view. The checkout operation is automatically expanded and extended to all source trees that are referenced in the collection view.

Expansion of Collection Views

The main goal of the present invention is to deliver collection view information to application programs, so that the programs can usefully manipulate collection views in productive ways that were not previously possible.

In operation, an application program invokes a collection view expander to produce collection view information from collection views cited in collection specifiers.

Having summarized the structure and some typical uses of collections, collection view references, and collection view reference type definitions, we now describe a preferred embodiment of the present Collection View Expander invention.

Module Expand Collection Reference Means

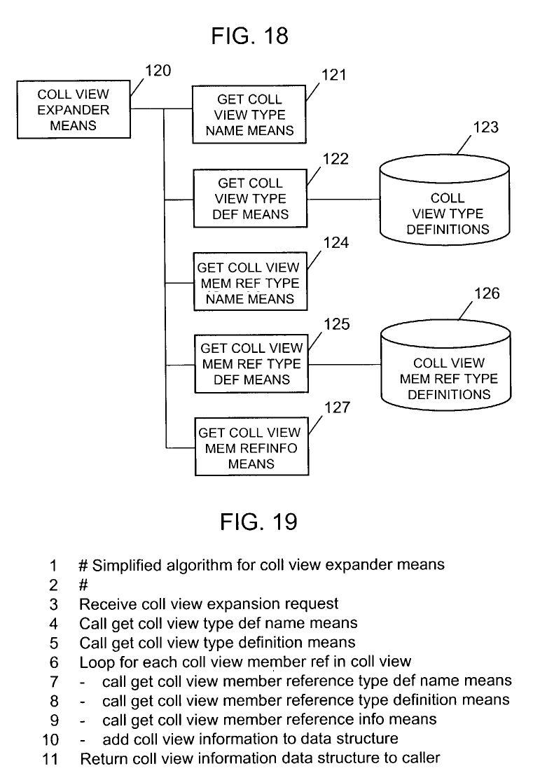

FIG. 18 shows a simplified architecture for a Collection View Expander Means 120.

Module Get Collection View Type Name Means 121 obtains a collection view type indicator FIG. 7 Line 18 Column 2 from a collection specifier file.

Module Get Collection View Type Definition Means 122 obtains collection view type definition information FIG. 15 from a database of collection view type definitions 123.

Module Get Collection View Member Reference Type Name Means 124 obtains collection view member reference type indicators FIG. 7 Lines 19-20 Column 1 for collection view member references in the collection view.

Module Get Collection View Member Reference Type Definition Means 125 obtains collection view member reference type definitions FIG. 13 from a database of collection view member reference type definitions 126, in accordance with the type indicator names obtained by Get Collection View Member Reference Type Name Means 124.

Module Get Collection View Member Information 127 obtains collection view member names and arguments from collection view member references in the collection view.

FIG. 19 shows a simplified algorithm for a Collection View Expander Means 120.

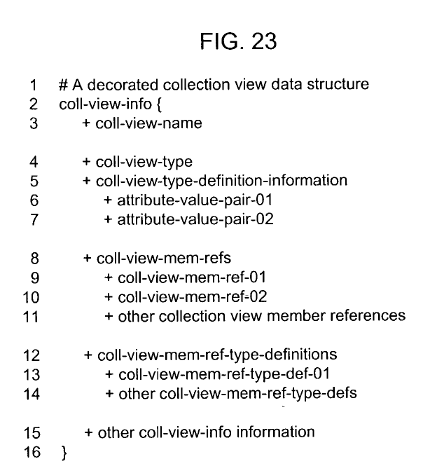

In operation, module Collection View Expander Means 120 receives a collection view to expand, from a calling module. The collection view could be stored in a partially filled data structure such as the one shown in FIG. 23. An unexpanded collection view would normally populate FIG. 23 Lines 3-4, 8-11, and possibly other fields represented by Line 15.

For each collection view, module Collection View Expander Means 120 first calls module Get Collection View Type Name Means 121 to obtain a collection view type name FIG. 7 Line 18 Column 2.

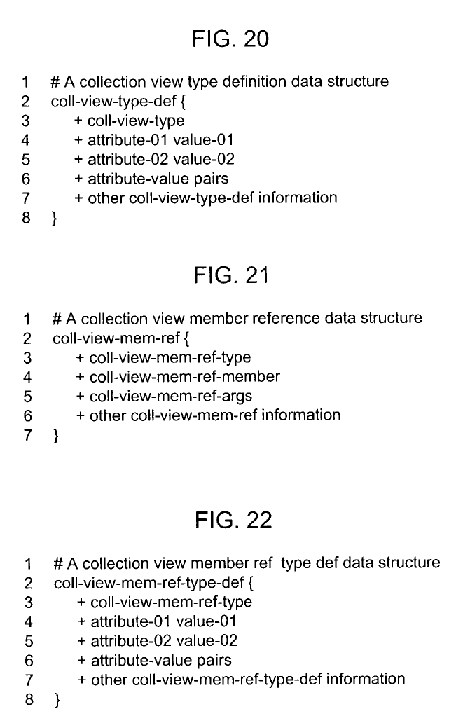

Next, it passes the obtained view type name to module Get Collection View Type Definition Means 122, which looks up the type name in Column 1 of a name-coll-type.tbl FIG. 10 to obtain a corresponding collection type definition filename from FIG. 10 Column 2. The filename points to a collection type definition such as shown in FIG. 11. Collection view type definition information could be stored in a data structure such as the one shown in FIG. 20.

For each collection member reference in a collection view, module Collection View Expander Means 120 calls Get Collection View Member Reference Type Name Means 124 to obtain a collection view member reference type name FIG. 7 Line 19 Column 1. Collection view member references could be stored in a data structure such as the one shown in FIG. 21.

Next, it passes the obtained type names to module Get Collection View Member Reference Type Definition Means 125, which looks up each type name in FIG. 12 Column 1 of a name-collview-mem-ref-type.tbl, to obtain a corresponding collection view member reference type definition filename from FIG. 12 Column 2. Having the name of a type definition filename, module Get Collection View Member Reference Type Definition Means 125 can access a corresponding detailed collection view member reference type definition file FIG. 13. The obtained type definition information could be stored in a data structure such as the one shown in FIG. 22.

Next, it calls module Get Collection View Member Information Means 127 to obtain collection view member information from the collection view member references. This information would normally be stored in a data structure specifically designed for the number of tokens in the collection member reference expression. Such a data structure would be easily designed by one of ordinary skill in the art.

Finally, module Collection View Expander Means 120 passes all obtained collection view information back to its caller module. Obtained collection view information could be stored in a collection view information data structure such as the one shown in FIG. 23.

FIG. 23 shows a simplified data structure for collection view information. The data structure is comprised of a collection view name Line 3, a collection view type Line 4, a set of collection view type definition attributes Lines 5-7, a list of collection view member references Lines 8-11, a list of associated collection view member reference type definitions Lines 12-14, and other collection view information.

Although the data structure FIG. 23 is shown here as a single data structure, those of ordinary skill in the art know that collection view information could easily be represented in multiple smaller data structures, or in other equivalent data structures, without loss of purpose or functionality.

An Example Collection View Checkout Operation

Collection views offer significant productivity advantages because they enable application programs and human knowledge workers to perform single operations on whole collection views, instead of having to perform tedious multiple, repetitive operations on individual collections. Collection views thereby promote the increased use of automation, as well as conceptual simplicity.

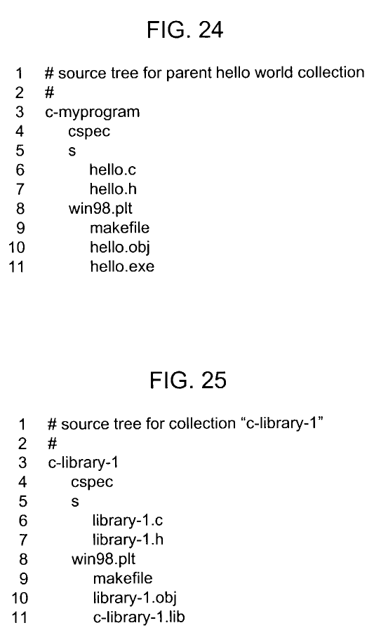

FIGS. 24-26 illustrate a typical application of collection views.

FIG. 24 shows an example collection for a simple application program “c-myprogram” that uses several link libraries to accomplish its function. FIG. 7 shows an example collection specifier for the collection shown FIG. 24. The collection specifier contains several collection view references FIG. 7 Lines 11-14.

FIG. 25 shows an example standalone collection source tree for one of the libraries “c-library-1” required by the program collection shown in FIG. 24.

Without the use of collection views, a software developer would normally follow several repetitive steps in order to build “c-myprogram” from its various parts. Specifically, the developer would check out the “c-myprogram” collection, check out the “c-library-1” collection, check out the “c-library-2” collection, check out the “c-mytree” source tree, then build each library individually, then finally build the “c-myprogram” and link in the library files. This sequence involves 4 checkouts and 4 builds, totaling 8 operations.

In contrast, collection views enable the software developer to issue only two commands: check out the view, and then build the view.

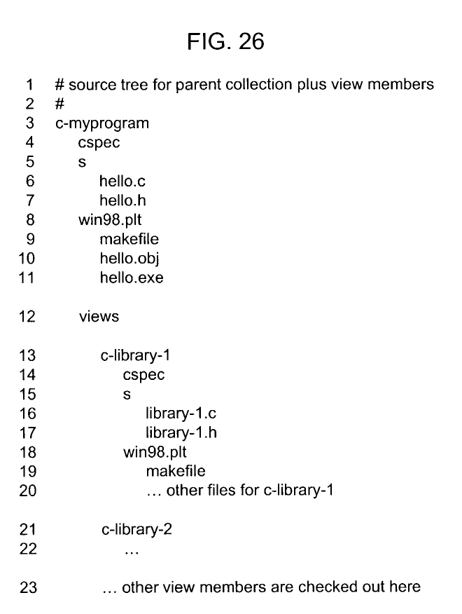

FIG. 26 shows an example composite source tree created by using collection views to check out the parent “c-myprogram” collection and the associated libraries. A comparison of FIG. 24 Lines 3-11 (the non-views checkout) with FIG. 26 Lines 3-11 (the views checkout) shows an identical structure for the parent collection “c-myprogram.”

FIG. 26 Line 12 shows a special directory into which collection view members are placed during check out operations. This directory “views” is specified by the collection view type definition attribute shown in FIG. 15 Line 5.

FIG. 26 Lines 13-20 show an example source tree for the “c-library-1” collection as part of the views checkout directory structure. It was shown in standalone form in FIG. 25.

FIG. 26 Lines 21-23 show where other collection view members would be placed during checkout operations.

Once the whole collection view is checked out, a software developer can issue a single “build” order, to a collection-view-enabled application program, to build the entire view.

Platform-Dependent Collection View Member References

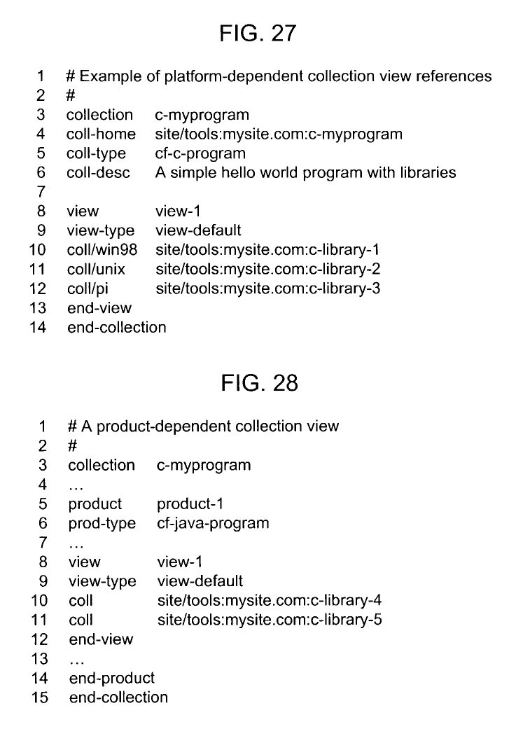

FIG. 27 shows an example collection specifier file that contains platform-dependent collection view member references. Platform-dependent collection view member references are practical because they enable people to create platform dependent collection views. For example, it is common for software application programs to require different source trees or different libraries for proper operation on different computing platforms. Platform dependent collection views enable programmers to use the same collection to represent multiple different platform dependent views.

FIG. 27 Lines 10-12 show several platform dependent collection view member reference statements. Platform dependence is indicated by a string comprised of a slash “/” character followed by the user-defined name of a computing platform. For example, “/win98” and “/gnulinux” are user-defined (non-trademarked) platform specifiers. Line 12 shows a platform specifier “/pi” that means “platform independent,” so the collection view member reference on Line 12 would be included in collection views on all platforms.

Product-Dependent Collection Views

FIG. 28 shows an example collection specifier file that contains a product-dependent collection view. A collection specifier can contain multiple product definitions. Multiple product definitions enable people to build multiple products from the collection contents of a single collection.

FIG. 28 Lines 5-14 show one product definition within the collection specifier. Other integral product blocks of similar structure could also appear within the collection specifier. Line 5 specifies the symbolic product name. Line 6 defines the product type. Line 7 shows where other product specification lines would normally appear.

FIG. 23 Lines 8-12 show a product-dependent collection view. The view is product dependent because it appears within a collection specifier product block (that is, between Lines 5-14, which define the boundaries of the product block). Application programs would only process these particular collection view lines as part of working on the product block specified by Lines 5-14.

### CONCLUSION

The present Collection View Expander invention has many practical applications in the technological arts. It enables programs and people to reference and manipulate whole groups of related collections using convenient collection views.

It provides practical solutions to seven important problems faced by people who work with groups of related collections. The problems are: (1) the Collection View Problem, (2) the Collection View Type Problem, (3) the Collection View Member Reference Problem, (4) the Collection View Member Reference Type Problem, (5) the Collection View Information Problem, (6) the Platform Dependent Collection View Member Reference Problem, and (7) the Product Dependent Collection View Problem.

In particular, the present invention makes it possible for people and computer programs to reference groups of collections, using a scalable and convenient syntax that was not previously known to the art.

Ramifications

Although the foregoing descriptions are specific, they should be considered as example embodiments of the invention, and not as limitations of the invention. Many other possible ramifications can be imagined within the teachings of the disclosures made here.

General Software Ramifications

The foregoing disclosure has recited particular combinations of program architecture, data structures, and algorithms to describe preferred embodiments. However, those of ordinary skill in the software art can appreciate that many other equivalent software embodiments are possible within the teachings of the present invention.

As one example, data structures have been described here as coherent single data structures for convenience of presentation. But information could also be spread across a different set of coherent data structures, or could be split into a plurality of smaller data structures for implementation convenience, without loss of purpose or functionality.

As a second example, particular software architectures have been presented here to strongly associate primary algorithmic functions with primary modules in the software architectures. However, because software is so flexible, many different associations of algorithmic functionality and module architectures are also possible, without loss of purpose or technical capability. At the under-modularized extreme, all algorithmic functionality could be contained in one big software module. At the over-modularized extreme, each tiny algorithmic function could be contained in a separate little software module. Program modules could be contained in one executable, or could be implemented in a distributed fashion using client-server architectures and N-tier application architectures, perhaps involving application servers and servlets of various kinds.

As a third example, particular simplified algorithms have been presented here to generally describe the primary algorithmic functions and operations of the invention. However, those skilled in the software art know that other equivalent algorithms are also easily possible. For example, if independent data items are being processed, the algorithmic order of nested loops can be changed, the order of functionally treating items can be changed, and so on.

Those skilled in the software art can appreciate that architectural, algorithmic, and resource tradeoffs are ubiquitous in the software art, and are typically resolved by particular implementation choices made for particular reasons that are important for each implementation at the time of its construction. The architectures, algorithms, and data structures presented in this disclosure comprise one such implementation, which was chosen to emphasize conceptual clarity.

From the above, it can be seen that there are many possible equivalent implementations of almost any software architecture or algorithm. Thus when considering algorithmic and functional equivalence, the essential inputs, outputs, associations, and applications of information that truly characterize an algorithm should be considered. These characteristics are much more fundamental to software inventions than are flexible architectures, simplified algorithms, or particular organizations of data structures.

Means for Storing and Retrieving Information

The foregoing disclosure used simple text files to illustrate structured tables of information, but other implementations are also possible. For example, all software means for retrieving information from the simple text files shown here might also be implemented to retrieve information from a relational database, or from a Collection Knowledge System (see the section on related patent applications at the beginning of this document).

Collection View Member Reference Syntax

The foregoing disclosure used a simple text-oriented, token-oriented syntax for collection specifier files and collection view member references. However, other syntaxes and representations are also possible. For example, collection specifiers and collection view references could also be implemented using relational databases, or binary data files, without loss of purpose or function.

Collection View Member Reference Expressions

The foregoing disclosure used three example syntaxes for collection view member reference expressions within collection view references, as illustrated in FIG. 9 Lines 3-10. However, other syntaxes for collection view member references are possible. For example, collection view member reference expressions could be formulated for use with relational databases, for other local application programs that provided access to source trees, or for use with network servers of various kinds. The essential functions provided by collection view member reference expressions are to identify, or provide access to, a collection view member (a source tree) that is part of a collection view.

Collection View Member Reference Types

The foregoing disclosure cited several collection view member reference types that were strongly associated with systems that provided access to collection view member source trees. For example, the disclosure cited “css” (a collection storage system), “cvs” (a version control system) and “http” (a web protocol system) as possible (non-trademarked) collection view member reference types. However, other schemes for organizing type names are possible. For example, type names could be chosen according to the purpose intended for the collection view reference. Types could be associated with tasks such as “assemble and build,” or “do test runs.” Or type names could cause application programs to dynamically invoke a calculation means to dynamically determine an appropriate collection view member reference type for the collection view member reference.

Collection View Member Reference Type Definitions

The foregoing disclosure described several possible attributes for collection view member reference type definitions, as shown in FIGS. 12-13. However, the attributes shown here are neither essential nor mandatory. Type definition attributes are user-defined, and can be adjusted to suit the requirements of the application programs that will ultimately read and use attribute values to process collections and collection views.

Collection View Expander Means

The foregoing disclosure described a Collection View Expander Means as a software architecture comprised of five major subordinate modules. However, other groupings of functionality into subordinate modules are possible. For example, since the functions performed by the subordinate modules shown here are simple, all functionality could be easily combined into one module by one of ordinary skill in the art.

Alternative Implementations

The foregoing disclosure used a simple architecture to illustrate how a Collection View Expander Means 120 could be used by an Application Program 110 to expand collection view references into collection view information. But other implementations are possible. For example, the functions performed by subordinate modules could be implemented as a client-server means that provided services across a network, as shown in FIG. 17. This approach would reduce the risk of having different expansion policies and behaviors among various application programs within an organization.

Practical Applications

The present Collection View Expander invention has many practical applications in the technical arts. For example, configuration management systems and automated software build systems could use Collection View Expanders to make it easier for people to perform operations on whole groups of collections. In general, any human or computer program that works with groups of collections can benefit from the present invention.

Scope

The full scope of the present invention should be determined by the accompanying claims and their legal equivalents, rather than from the examples given in the specification.

I claim:

1. A Collection View Expander process for delivering collection view information to programs, to be performed on or with the aid of a computer, comprising the following steps:
(a) receiving an expansion request to expand a collection view,
(b) performing an expansion action to produce collection view information, using information from said collection view, and
(c) returning said collection view information to the request originator,
wherein a collection view is comprised of a collection view type and collection view member references, and wherein a collection view member reference is comprised of a collection view member reference type indicator and a collection view member reference expression, and wherein collection view information is comprised of a collection view, a collection view type, collection view type definition information, a list of collection view member references, and a list of corresponding collection view member reference type definition information,
thereby solving the Collection View Problem, solving the Collection View Information Problem, and improving the productivity of people who work with collections and collection views.

2. The process of claim 1, wherein
(a) said step of performing an expansion action uses a Get Collection View Type Name Means to obtain a collection view type indicator from said collection view,
thereby solving the Collection View Type Problem, and thereby improving human productivity by enabling application programs to access detailed attribute-value type definition information to process collection views in ways that were not previously possible.

3. The process of claim 1, wherein
(a) said step of performing an expansion action uses a Get Collection View Member Reference Type Name Means to obtain a collection view member reference type name for a collection view member reference from said collection view,
thereby solving the Collection View Member Reference Type Name Problem, and thereby improving human productivity by providing application programs with detailed attribute-value type definition information so programs can usefully manipulate collection views in more advanced ways that were not previously known to the art.

4. The process of claim 1, wherein
(a) said step of performing an expansion action uses a database of collection view type definitions to obtain collection view type definition information,
thereby helping to solve the Collection View Type Definition Problem, and thereby improving human productivity by organizing collection view type definitions in a conveniently accessible data storage system.

5. The process of claim 1, wherein
(a) said step of performing an expansion action uses a database of collection view member reference type definitions to obtain collection view member reference type definition information,
thereby helping to solve the Collection View Member Reference Type Definition Problem, and thereby improving human productivity by organizing collection view reference type definitions in a conveniently accessible data storage system.

6. The process of claim 1, wherein
(a) said step of performing an expansion action uses a Get Collection View Member Information Means to obtain collection view member expression information from said collection view,
thereby helping to solve the Collection View Reference Problem, and thereby making it possible for collection view references to refer to collection view members that are stored in various data storage systems that require different syntaxes for referencing stored source trees.

7. The process of claim 1, wherein
(a) said step of performing an expansion action uses a platform dependent collection view member reference from said collection view,
thereby solving the Platform Dependent Collection View Reference Problem, and thereby enabling people to associate collection view member references with particular user-defined virtual platform names.

8. The process of claim 1, wherein
(a) said step of performing an expansion action uses a product dependent collection view from said collection view,
thereby solving the Product Dependent Collection View Problem, and thereby enabling people to associate collection views with particular collection products within a collection specifier.

9. A programmable Collection View Expander device for delivering collection view information to programs, whose actions are directed by software executing a process comprising the following steps:
(a) receiving an expansion request to expand a collection view,
(b) performing an expansion action to produce collection view information, using information from said collection view, and
(c) returning said collection view information to the request originator,
wherein a collection view is comprised of a collection view type and collection view member references, and wherein a collection view member reference is comprised of a collection view member reference type indicator and a collection view member expression, and wherein collection view information is comprised of a collection view, a collection view type, collection view type definition information, a list of collection view member references, and a list of corresponding collection view member reference type definition information,
thereby solving the Collection View Problem, solving the Collection View Information Problem, and improving the productivity of people who work with collections and collection views.

10. The programmable device of claim 9, wherein
(a) said step of performing an expansion action uses a Get Collection View Type Name Means to obtain a collection view type indicator from said collection view,
thereby solving the Collection View Type Problem, and thereby improving human productivity by enabling application programs to access detailed attribute-value type definition information to process collection views in ways that were not previously possible.

11. The programmable device of claim 9, wherein
(a) said step of performing an expansion action uses a Get Collection View Member Reference Type Name Means to obtain a collection view member reference type name for a collection view member reference from said collection view,
thereby solving the Collection View Member Reference Type Name Problem, and thereby improving human productivity by providing application programs with detailed attribute-value type definition information so programs can usefully manipulate collection views in more advanced ways that were not previously known to the art.

12. The programmable device of claim 9, wherein
(a) said step of performing an expansion action uses a database of collection view type definitions to obtain collection view type definition information,
thereby helping to solve the Collection View Type Definition Problem, and thereby improving human productivity by organizing collection view type definitions in a conveniently accessible data storage system.

13. The programmable device of claim 9, wherein
(a) said step of performing an expansion action uses a database of collection view member reference type definitions to obtain collection view member reference type definition information,
thereby helping to solve the Collection View Member Reference Type Definition Problem, and thereby improving human productivity by organizing collection view reference type definitions in a conveniently accessible data storage system.

14. The programmable device of claim 9, wherein
(a) said step of performing an expansion action uses a Get Collection View Member Information Means to obtain collection view member expression information from said collection view,
thereby helping to solve the Collection View Reference Problem, and thereby making it possible for collection view references to refer to collection view members that are stored in various data storage systems that require different syntaxes for referencing stored source trees.

15. The programmable device of claim 9, wherein
(a) said step of performing an expansion action uses a platform dependent collection view member reference from said collection view,
thereby solving the Platform Dependent Collection View Reference Problem, and thereby enabling people to associate collection view member references with particular user-defined virtual platform names.

16. The programmable device of claim 9, wherein
(a) said step of performing an expansion action uses a product dependent collection view from said collection view,
thereby solving the Product Dependent Collection View Problem, and thereby enabling people to associate collection views with particular collection products within a collection specifier.

17. A computer readable memory, encoded with data representing a Collection View Expander computer program, that can be used to direct a computer when used by the computer, comprising:
(a) means for receiving an expansion request to expand a collection view,
(b) means for performing an expansion action to produce collection view information, using information from said collection view, and
(c) means for returning said collection view information to the request originator,
wherein a collection view is comprised of a collection view type and collection view member references, and wherein a collection view member reference is comprised of a collection view member reference type indicator and a collection view member expression, and wherein collection view information is comprised of a collection view, a collection view type, collection view type definition information, a list of collection view member references, and a list of corresponding collection view member reference type definition information,
thereby solving the Collection View Problem, solving the Collection View Information Problem, and improving the productivity of people who work with collections and collection views.

18. The computer readable memory of claim 17, wherein
(a) said means for performing an expansion action uses a Get Collection View Type Name Means to obtain a collection view type indicator from said collection view,
thereby solving the Collection View Type Problem, and thereby improving human productivity by enabling application programs to access detailed attribute-value type definition information to process collection views in ways that were not previously possible.

19. The computer readable memory of claim 17, wherein
(a) said means for performing an expansion action uses a Get Collection View Member Reference Type Name Means to obtain a collection view member reference type name for a collection view member reference from said collection view,
thereby solving the Collection View Member Reference Type Name Problem, and thereby improving human productivity by providing application programs with detailed attribute-value type definition information so programs can usefully manipulate collection views in more advanced ways that were not previously known to the art.

20. The computer readable memory of claim 17, wherein
(a) said means for performing an expansion action uses a database of collection view type definitions to obtain collection view type definition information,
thereby helping to solve the Collection View Type Definition Problem, and thereby improving human productivity by organizing collection view type definitions in a conveniently accessible data storage system.

21. The computer readable memory of claim 17, wherein
(a) said means for performing an expansion action uses a database of collection view member reference type definitions to obtain collection view member reference type definition information,
thereby helping to solve the Collection View Member Reference Type Definition Problem, and thereby improving human productivity by organizing collection view reference type definitions in a conveniently accessible data storage system.

22. The computer readable memory of claim 17, wherein
(a) said means for performing an expansion action uses a Get Collection View Member Information Means to obtain collection view member expression information from said collection view,
thereby helping to solve the Collection View Reference Problem, and thereby making it possible for collection view references to refer to collection view members that are stored in various data storage systems that require different syntaxes for referencing stored source trees.

23. The computer readable memory of claim 17, wherein
(a) said means for performing an expansion action uses a platform dependent collection view member reference from said collection view,
thereby solving the Platform Dependent Collection View Reference Problem, and thereby enabling people to associate collection view member references with particular user-defined virtual platform names.

24. The computer readable memory of claim 17, wherein
(a) said means for performing an expansion action uses a product dependent collection view from said collection view,
thereby solving the Product Dependent Collection View Problem, and thereby enabling people to associate collection views with particular collection products within a collection specifier.
